(19) United States
(12) Patent Application Publication
(10) Pub. No.: US 2010/0000391 A1
(43) Pub. Date: Jan. 7, 2010

(54) Universal Coin Roll Opener

(76) Inventor: Mohamed K. S. Mohamed, Ventura, CA (US)

Correspondence Address: Mohamed K.S. Mohamed, 251 N. Ventura Avenue, Spc. 41, Ventura, CA, 93001, US

(21) Appl. No.: 12/131,095

(22) Filed: Jul. 1, 2008

(51) Int. Cl. B26D 1/02

(52) U.S. Cl. 83/856

(57) ABSTRACT

A coin roll opening device consisting of a solid rectangular block wherein a longitudinal V-shaped indentation is carved out of the top surface of said block. Said V-shaped indentation is carved out from the front end of the solid block all the way to the back end and is a few centimeters equally distant from the sides of said block. In the bottom of said V-shaped indentation is a short-longitudinal incision. A blade mean is securely inserted in said incision. The longitudinal V-shaped indentation receives a wrapped roll of coins. When the wrapped roll of coins is pushed from the front to the back against the blade mean, the wrapper is sliced lengthwise and easy access to the coins is achieved. Along the left side and the right side of the solid block is a grove that runs from the front end all the way to the back end. Said groves receive a cover that moves back and forth within the groves. When the cover is pushed backward it exposes the blade and when it is pushed forward it covers the blade.

### BACKGROUND OF THE INVENTION

This invention relates to device for quickly and conveniently removing coins from its wrapper by slicing the wrapper.

It is common practice for banks, businesses, and individuals who rely on tips for income to use coin wrappers. The wrapper is either paper or plastic. Opening either kind of wrapper presents a challenge and sometimes a danger if a knife or a blade is used.

There are several patented inventions for coin roll opening devices such as:
1. U.S. Pat. No. 5,123,320 and U.S. Pat. No. 4,852,255 by Hochfeld.
2. U.S. Pat. No. 4,001,934 by Bell.
3. U.S. Pat. No. 4,852,253 by Uchid.
4. U.S. Pat. No. 4,757,611 Tommi et al.
5. U.S. Pat. No. 4,040,183 by Cassier.
6. U.S. Pat. No. 5,086,962 by Costello.

None of the above inventions have the effectiveness of opening the roll of coins, the simplicity of design, nor the ease of use as my invention does. U.S. Pat. No. 4,040,183 is simply designed but it does not work as my personal experience has proven. U.S. Pat. No. 5,123,320 requires the person to strike the roll of coins against a blade in order to create a circular cut in the wrapper. More effort is required to remove the coins from the tightly rolled wrappers. In addition, any hard edge surface, which is abundant in most environments, can substitute for this particular art which relies on opening a roll of coins by striking it against such a surface.

### SUMMARY OF THE INVENTION

It is the purpose of my invention to provide a coin roll opening device for opening any roll of coins effectively, safely, quickly, and conveniently.

It is another purpose of my invention to prevent the user from exerting any additional effort in order to cut, sever, or slice the coin wrappers.

It is still a further purpose of my invention is to prevent the coins from falling and scattering after the wrapper has been sliced.

It is also a purpose of my invention to provide a coin roll opening device that uses a very small space anywhere where opening rolls of coins is required.

It is another purpose of my invention to provide a coin roll opening device that can not be misplaced or lost. The device can either be affixed to a counter top or a system of two eye-screws and a chain. In the later case, one eye screw will be attached to the device. Each end of the chain will be attached to an eye screw. The second eye screw will be attached to counter top or a stable surface.

### A BRIEF DESCRIPTION OF THE DRAWINGS

FIG. 1 is a perspective view of the embodiment of my invention showing a wrapped roll of coins being pushed against a blade while the cover is pushed to the back or the open position.

FIG. 2 is a perspective view of my invention showing a short longitudinal incision in the bottom of the V-shape.

FIG. 3 shows a perspective view of general right angle triangle blade mean.

FIG. 4 is a perspective view of the cover.

FIG. 5 is perspective view of the embodiment of my invention showing a system of an eye screw connected to the coin roll opening device, a chain connected to said eye screw, and a second eye screw connected to the other end of the chain. This eye screw can be fastened to a desk top or any other stable surface.

### DETAILED DESCRIPTION

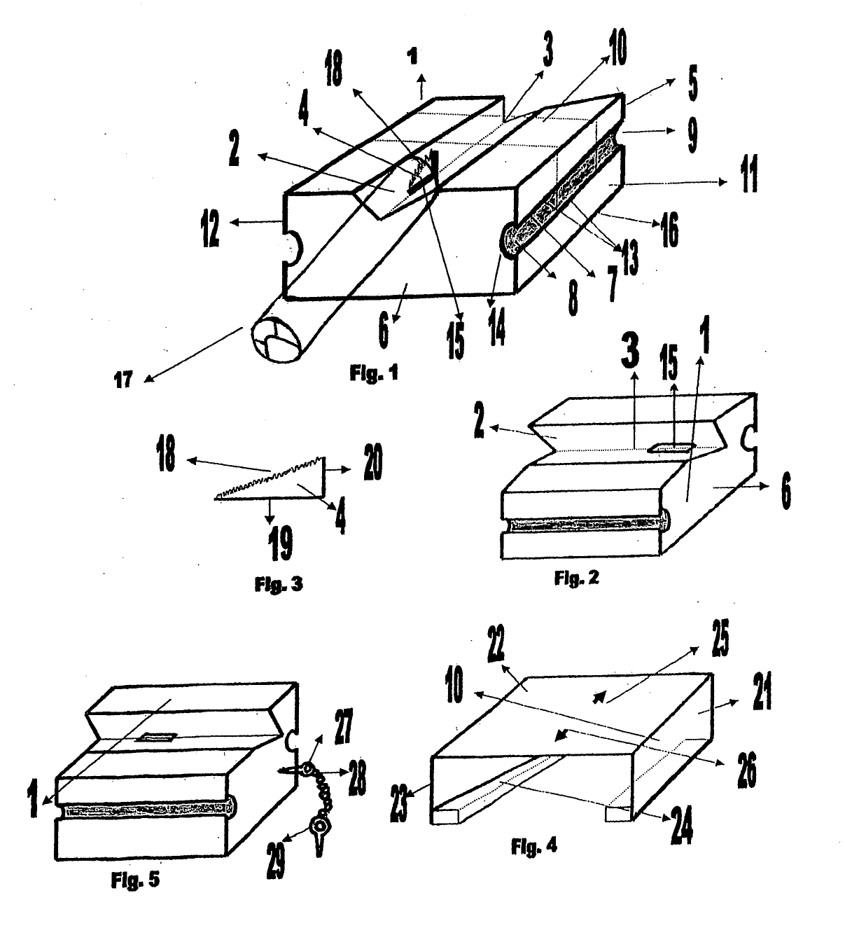

FIG. 1 depicts the embodiment of a coin roll opening device which is used to open a wrapped roll of coins.

The coin roll opening device of my invention, as shown in FIG. 1, consists of: a solid rectangular block with a longitudinally carved-out V-shaped indentation 2 on the top surface of the block. The solid rectangular block is made of wood, molded plastic, metal, granite, or any other suitable material. FIG. 1 also shows a blade mean 3 made of hardened and serrated metal. A smooth-edged metal, hard plastic or any other suitable material can be used. The blade mean can be of any shape but a general right angle triangle where the hypotenuse represents the sharp edge is shown in FIG. 1.

The coin-roll opening device 1, as seen in FIG. 1, has a rectangular shape profile. The profile can be a cube, a square, or any other shape.

The carved out V-shape indentation 2 can be changed for a circular shape or any other suitable shape. The indentation should be wide enough in order to receive the largest roll of coins available. The indentation should be deep enough so when a blade mean is inserted and secured in the bottom of said indentation the blade does not pose any danger to the user.

The coin roll opening device 1, as shown in FIG. 1, shows the right side 11 of the device where a longitudinal groove 7 runs from the front end 6 all the way to the back end 5 of said device. Said groove 7 consists of two lips 13 and a cavity 14. The front end of the groove 8 is opened in order to allow a cover or a lid to go inside said groove. The back end 9 of said groove 7 is closed in order to prevent the cover from sliding out completely. A different design of the groove can be made wherein the back end 9 of the groove 7 is opened but narrower than the front 8 of said groove. The cover, in this case, will be designed with its bottom edges, or ridges 24 are thicker in the front and thinner as they slope to the back. When the thick parts of the ridges reach the narrow part of the grooves, they do not slide out.

The left side 12 of the solid block 1 is identical to the right side 11 of said block FIG. 2 shows the embodiment of a coin roll opening device 1 wherein a short-longitudinal incision 15 in the bottom of the V-shape indentation 3 is cut. This incision should be deep enough in order to secure the blade mean and prevent it from jerking to the left or to the right. Said incision is just long enough to host the blade mean and prevent it from moving backward or forward when the roll of coins is pressed against it. The incision 15 is cut closer to the front end 6 of the solid block or at any distance that allows the wrapped roll of coins to be completely sliced from one end to the other.

FIG. 3 shows a general right angle triangle blade mean 4 wherein the hypotenuse 18 is the serrated sharp edge against which the roll of coins is pressed. The blade is very rigid and very sturdy so it does not bend or twist when the rolls of coins are pressed against it. The hypotenuse 18 of the blade 4 is serrated and very sharp so it can cut any wrapper whether it is made of paper or plastic. The leg 19 of the triangle blade rests firmly in the bottom of the incision 15 while the other leg 20 rests against the back end of the incision.

FIG. 4 shows a perspective view of the cover 10. The purpose of the cover is to hide the blade mean 4 when the device is not in use. The cover is a homogeneous one piece that consists of three sided planes, a right side 21, a top side 22, and a left side 23. The bottom edges 24 of the right and left sides of the cover turn to the inside to form ridges with its respective side. These ridges are smooth in order to allow the cover to move freely in the grooves 7.

FIG. 4 also shows two arrows on the top side 22 of the cover 10. One arrow 25 indicates the open position or the direction that will exposes the blade. The second arrow 26 indicates the closed position or the direction that will cover the blade.

The cover 10 of FIG. 4 can be completely redesigned where it acts as a case into which the entire coin roll opening device 1 can slide into and out of said cover. In this case, no grooves 7 are needed and the cover will be slightly larger in all its dimensions than the solid block. The bottom edges 24 of the cover will turn to the inside and form one half of an inch ridge with its respective side. These ridges will act as a rail upon which the coin roll opening device slides back and forth.

A different design where no cover 10 and no grooves 7 are needed. In this case, only a small three dimensional lid with a cavity in its center can be inserted over the blade mean in order to tightly cover it.

FIG. 5 is a perspective view of the coin roll opening device 1 showing an eye screw 27 connected to one end of the device. One end of a chain 28 is connected to the eye screw 27. A second eye screw 29 is connected to the other end of the chain 28. The second eye screw 29 can be screwed to a counter top, a wall, or any stable surface. If the user prefer, adhesive element can be used instead of the chain and the screws.

What I claim:

1. A coin roll opening device consisting of a solid rectangular block with a longitudinal V-shaped indentation carved out of the top surface of said block and running from the front end to the back end. The longitudinal V-shaped indentation is in the center of the block and is a few centimeters equally distant from the sides of the block. Said V shaped indentation is wide enough and deep enough to receive the largest roll of coins available. Said V-shaped indentation is deep enough in order to host a blade mean without posing any hazard to the user. The blade mean should never project up to or beyond the top surface of the rectangular block.

2. The coin roll opening device of claim 1 wherein a short-longitudinal incision is cut in the bottom of the V-shaped indentation of claim 1. Said short-longitudinal incision is a few centimeters from the front end of the solid block.

3. The coin roll opening device of claim 1 wherein a blade mean can be easily removed and replaced by a newer or sharper blade mean into the incision of claim 2.

4. The coin roll opening device of claim 1 wherein an instruction of using the device is displayed on one side of the top surface and a warning is displayed on the other side of said surface.

5. The coin roll opening device of claim 1 wherein a groove on the right side of the rectangular block runs from the front end all the way to the back end of said block.

6. The coin roll opening device of claim 1 wherein a groove on the left side of the rectangular block runs from the front end all the way to the back end of said block and is parallel to the groove of claim 5.

7. The coin roll opening device of claim 5 and 6 wherein the cavities of the grooves are large enough in order to host the bottom edges of a cover.

8. The coin roll opening device of claim 7 wherein each groove consists of two lips and a cavity.

9. The coin roll opening device of claim 5 and 6 wherein the grooves are opened from the front ends and are closed from the back ends in order to prevent the cover from sliding out from the back.

10. A homogeneous three-sided-cover plane consists of a right side, a top surface, and a left side. The bottom edges of the left and the right sides of the cover turn to the inside to form right angle ridges with its respective side. Said ridges are smooth and fit inside the grooves of claims 5 and 6.

11. The coin roll opening device of claim 10 wherein the cover is slightly wider than the solid block of claim 1 and is substantially shorter in length and height than said block.
